(19) United States
(12) Patent Application Publication
(10) Pub. No.: US 2019/0104194 A1
(43) Pub. Date: Apr. 4, 2019

(54) MODIFYING SERVER RESOURCES USING A CLIENT-SIDE PROXY

(71) Applicant: Facebook, Inc., Menlo Park, CA (US)

(72) Inventor: Andrew Harrison Imm, San Francisco, CA (US)

(21) Appl. No.: 15/725,279

(22) Filed: Oct. 4, 2017

(51) Int. Cl. H04L 29/08; H04L 29/06

(52) U.S. Cl. CPC H04L 67/28; H04L 67/32; H04L 67/42

(57) ABSTRACT

A computer-implemented method for modifying server resources using a client-side proxy may include (1) intercepting, at a proxy, a server resource request that was sent from a client application on a client device and directed to a remote server, (2) determining, at the proxy, a modification for a server resource response based on the request, (3) applying, at the proxy, the modification to the server resource response, and (4) sending, from the proxy, the modified server resource response to the client application. Various other methods, systems, and computer-readable media are also disclosed.

### BACKGROUND

In client-server computing systems, servers traditionally receive client application data requests and return appropriate responses. For example, web servers may receive and respond to requests for displaying a web page within a browser application on a client device. After receiving a request (e.g., for a web page), web servers may need to perform additional processing before returning a response back to a requesting client application. For example, a web server may need to modify a requested web page so that images and other content are formatted to display correctly in a particular web browser or on a particular device. However, modifications such as these often tax server resources, which may increase response time and adversely affect the experience of a user.

### SUMMARY

As will be described in greater detail below, the instant disclosure describes various systems and methods for modifying server resources using a client-side proxy by intercepting server resource requests and performing any necessary processing at the proxy prior to returning a response to a client.

In one example, a method for modifying server resources using a client-side proxy may include (1) intercepting, at a proxy, a server resource request that was sent from a client application on a client device and directed to a remote server, (2) determining, at the proxy, a modification for a server resource response based on the request, (3) applying, at the proxy, the modification to the server resource response, and (4) sending, from the proxy, the modified server resource response to the client application.

In some examples, the server resource request may include a request for a modified server resource. In such examples, the proxy may determine the modification for the server resource response by (1) changing the request for the modified server resource to a request for an unmodified server resource, (2) sending the request for the unmodified server resource to the remote server, (3) receiving a response including the unmodified server resource from the remote server, and (4) determining how to modify the unmodified server resource.

In some examples, the proxy may apply the modification to the server resource response by generating the server resource response without communicating with the remote server. In one example, applying the modification to the server resource response may include performing at least one task that the remote server is not capable of performing.

In one example, the proxy may include a process running on the client device. In this example, the client application may be a web browser running on the client device and the process running on the client device may include a background application programming interface (API) of the web browser.

In addition, a corresponding system for modifying server resources using a client-side proxy may include several modules stored in memory, including (1) an interception module that intercepts, at a proxy, a server resource request that was sent from a client application on a client device and directed to a remote server, (2) a determination module that determines, at the proxy, a modification for a server resource response based on the request, (3) an application module that applies, at the proxy, the modification to the server resource response, (4) a sending module that sends, from the proxy, the modified server resource response to the client application, and (5) at least one physical processor configured to execute the interception module, the determination module, the application module, and the sending module.

In some examples, the server resource request may include a request for a modified server resource. Additionally, the determination module may determine the modification for the server resource response by (1) changing the request for the modified server resource to a request for an unmodified server resource, (2) sending the request for the unmodified server resource to the remote server, (3) receiving a response including the unmodified server resource from the remote server, and (4) determining how to modify the unmodified server resource.

In some examples, the application module may apply the modification to the server resource response by generating the server resource response without communicating with the remote server. In one example, the application module may apply the modification to the server resource response by performing at least one task that the remote server is not capable of performing.

In some examples, the proxy may include a process running on the client device. In this example, the modified server resource response may be sent from a browser running on the client device and the process running on the client device may include a background application programming interface of the browser.

In some examples, the above-described method may be encoded as computer-readable instructions on a computer-readable medium. For example, a computer-readable medium may include one or more computer-executable instructions that, when executed by at least one processor of a computing device, may cause the computing device to (1) intercept, at a proxy, a server resource request that was sent from a client application on a client device and directed to a remote server, (2) determine, at the proxy, a modification for a server resource response based on the server resource request, (3) apply, at the proxy, the modification to the server resource response, and (4) send, from the proxy, the modified server resource response to the client application.

In some examples, the server resource request may include a request for a modified server resource. Additionally, the computer-executable instructions may cause the computing device to determine, at the proxy, the modification for the server resource response by (1) changing the request for the modified resource to a request for an unmodified server resource, (2) sending the request for the unmodified server resource to the remote server, (3) receiving a response including the unmodified server resource from the remote server, and (4) determining how to modify the unmodified server resource.

In some examples, the computer-executable instructions may cause the computing device to apply the modification to the server resource response by generating the server resource response without communicating with the remote server. In one example, the computer-executable instructions may cause the computing device to apply the modification to the server resource response by performing at least one task that the remote server is not capable of performing.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a block diagram of an exemplary system for modifying server resources using a client-side proxy.

FIG. 2 is a block diagram of another exemplary system for modifying server resources using a client-side proxy.

FIG. 3 is a block diagram of another exemplary system for modifying server resources using a client-side proxy.

FIG. 4 is a flow diagram of an exemplary method for modifying server resources using a client-side proxy.

FIG. 5 is a communication chart for an example system performing the example method of FIG. 4.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

The present disclosure is generally directed to systems and methods for modifying server resources using a client-side proxy. As will be explained in greater detail below, embodiments of the instant disclosure may provide a proxy on a client device having one or more client applications that generate server resource requests. The proxy, which may be implemented as a service worker, may intercept server resource requests and perform at least some of the processing involved in generating responses to the requests.

The disclosed systems and methods may provide one or more advantages over traditional methods for processing client resource requests made to a server. In traditional systems, if a client requests a modified resource, the server may need to either compute that new object on demand or load stored data from a previously computed response. Either approach may incur some cost, and possibly a significant cost, for the server. With the disclosed proxy in place, a client application may still make network requests as before, but some or all of the processing may also be done client-side by a proxy. Thus, the disclosed systems and methods may improve the functioning of a server in a client-server computer network by enabling processing to be distributed among clients and servers, rather than being handled primarily server-side.

By moving processing tasks involved in responding to client requests to the clients making the requests, the systems and methods described herein may enable better balancing of server workloads. For example, client-side processing systems may be used to ensure that high-demand clients do not reduce a server's responsiveness to other clients (i.e., because the work performed by a client may be directly correlated to the requests the client makes). As another example, client-side processing may enable more efficient response times for server workloads that are not easily or practically cached and/or may enable servers to handle more requests from clients. Furthermore, since a client may be capable of performing some tasks that a target server cannot, client-side processing of requests to servers may facilitate adding functionality to server request responses without changing (e.g., upgrading) the target server.

The disclosed systems and methods may also enable sharing a server-resource modification proxy among multiple applications on a given web domain, which may reduce or eliminate duplication of logic between individual applications. Moreover, the disclosed systems and methods may enable a server to service endpoints that it might not have been able to service otherwise. Embodiments of the instant disclosure may also provide a variety of other features and advantages over traditional systems, as explained in the following description of the accompanying figures.

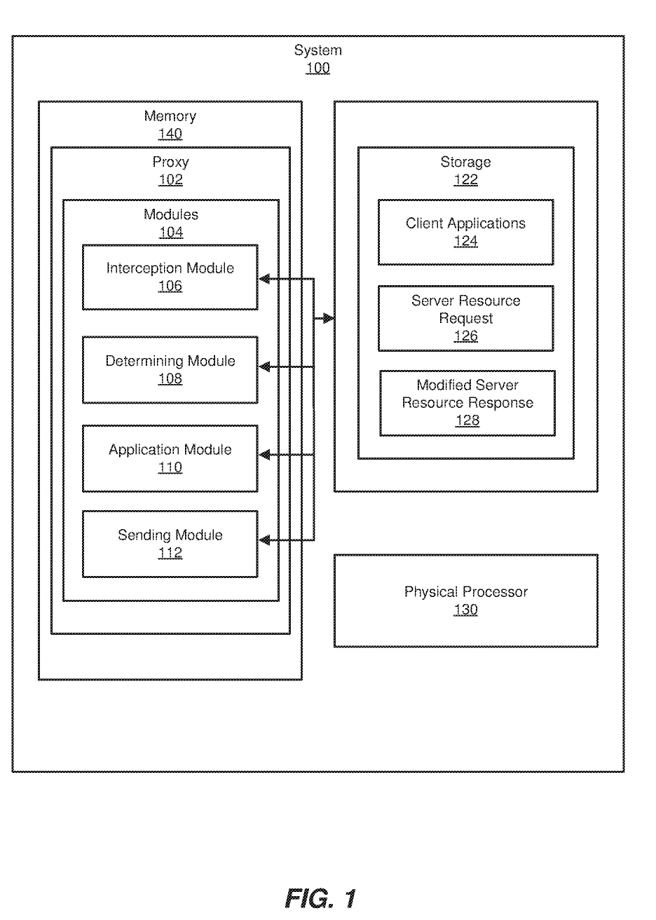

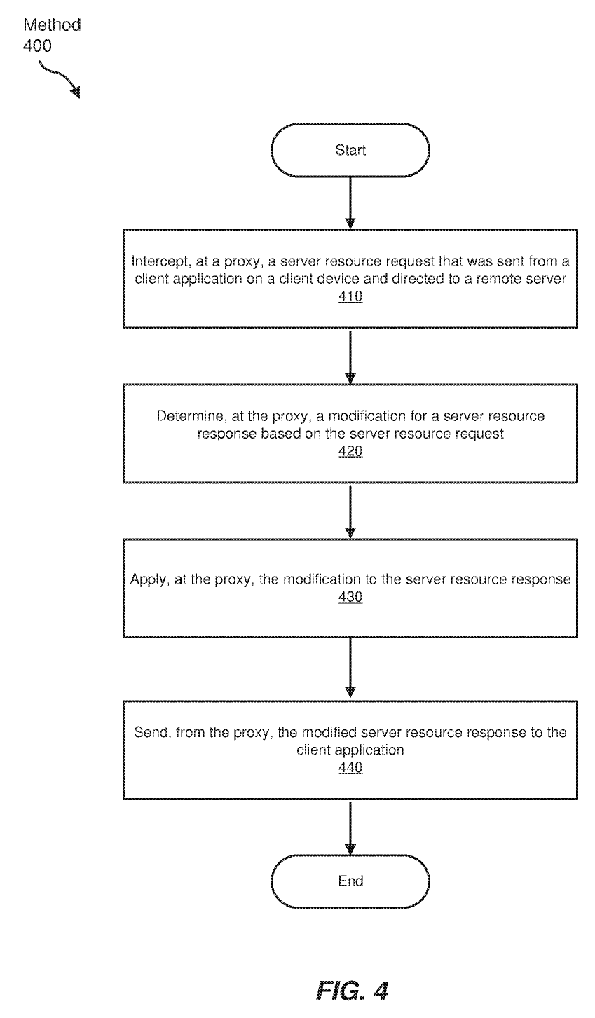

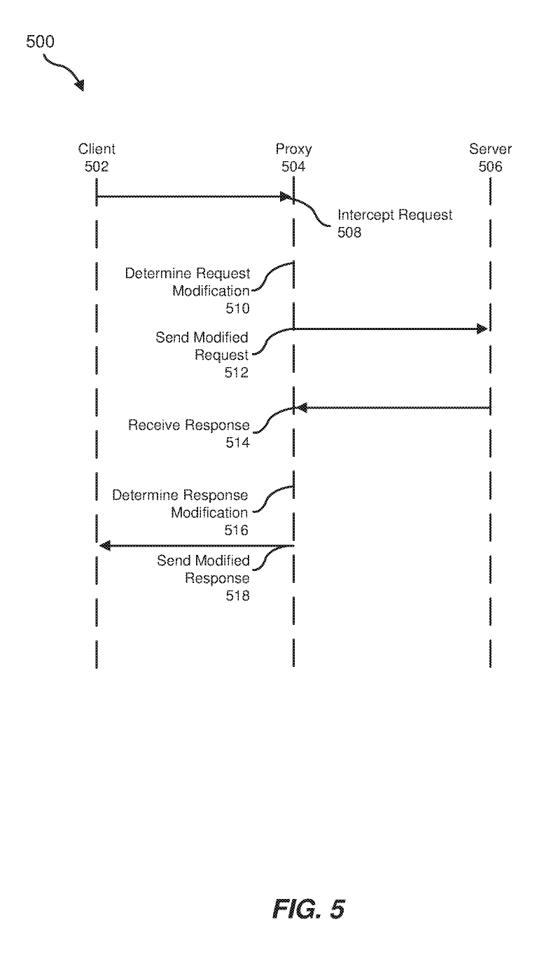

The following will provide, with reference to FIGS. 1-3, detailed descriptions of example systems for modifying server resources using a client-side proxy. Detailed descriptions of corresponding computer-implemented methods and a communication chart will also be provided in connection with FIGS. 4-5.

FIG. 1 is a block diagram of an example system 100 for modifying server resources using a client-side proxy. As illustrated in this figure, example system 100 may include a proxy 102 containing one or more modules 104 for performing one or more tasks. As will be explained in greater detail below, modules 104 may include an interception module 106 that intercepts a server resource request 126 sent from a client application (e.g., one of client applications 124) and directed to a remote server. Example system 100 may also include a determining module 108 that determines a modification for a server resource response based on server resource request 126. Example system 100 may further include an application module 110 that applies the modification to the server resource response without utilizing resources of the remote server. In addition, system 100 may include a sending module 112 that sends, from proxy 102, a modified server resource response 128 to a client application 124. Although illustrated as separate elements, one or more of modules 104 in FIG. 1 may represent portions of a single module or application.

The term “proxy,” as used herein, generally refers to a client-side web service in a client-server network that may intercept server requests from client applications and handle at least some of the processing involved in responding to the requests.

The term “server resource request,” as used herein, generally refers to a client application request to a server for data (e.g., web pages, images, etc.) over a network. The term “server resource response” generally refers to data generally provided by the server utilizing varying amounts of server resources (e.g., processing and memory resources) for sending to a requesting client application over a network. As will be explained in greater detail below, a client-side proxy (e.g., proxy 102) may also be utilized to receive server resource requests and generate server resource responses as if it were the server itself (e.g., the proxy may be configured to perform server tasks locally).

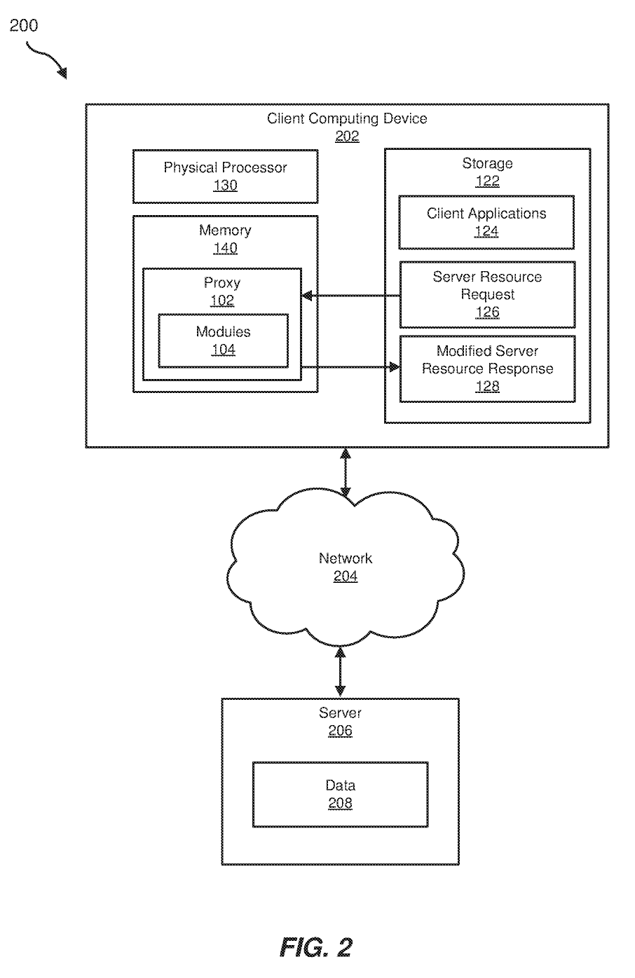

In certain embodiments, one or more of modules 104 in FIG. 1 may represent one or more software applications or programs that, when executed by a computing device, may cause the computing device to perform one or more tasks. For example, and as will be described in greater detail below, one or more of modules 104 may represent modules stored and configured to run on one or more computing devices, such as the devices illustrated in FIG. 2 (e.g., client computing device 202 and/or server 206). One or more of modules 104 in FIG. 1 may also represent all or portions of one or more special-purpose computers configured to perform one or more tasks.

As illustrated in FIG. 1, example system 100 may also include one or more memory devices, such as memory 140. Memory 140 generally represents any type or form of volatile or non-volatile storage device or medium capable of storing data and/or computer-readable instructions. In one example, memory 140 may store, load, and/or maintain one or more of modules 104. Examples of memory 140 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

As illustrated in FIG. 1, example system 100 may also include one or more physical processors, such as physical processor 130. Physical processor 130 generally represents any type or form of hardware-implemented processing unit capable of interpreting and/or executing computer-readable instructions. In one example, physical processor 130 may access and/or modify one or more of modules 104 stored in memory 140. Additionally or alternatively, physical processor 130 may execute one or more of modules 104 to facilitate modifying server resources using a client-side proxy. Examples of physical processor 130 include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, and/or any other suitable physical processor.

As illustrated in FIG. 1, system 100 may also include storage 122 that stores client applications 124, server resource request 126, and modified server resource response 128. As will be described in greater detail below, modules 104 in proxy 102 may be utilized to determine a modified response based on an intercepted server resource request 126 from a client application 124 and perform additional processing to apply the modification (e.g., to generate the requested response), thereby reducing or eliminating a load on processing resources on a networked server.

Example system 100 in FIG. 1 may be implemented in a variety of ways. For example, all or a portion of example system 100 may represent portions of example system 200 in FIG. 2. As shown in FIG. 2, system 200 may include a client computing device 202 in communication with server 206 via a network 204. In one example, all or a portion of the functionality of modules 104 in proxy 102 may be performed by client device 202, server 206, and/or any other suitable computing system. As will be described in greater detail below, one or more of modules 104 from FIG. 1 may, when executed by at least one processor of client computing device 202, enable client computing device 202 to transform network resources. For example, and as will be described in greater detail below, one or more of modules 104 in proxy 102 may cause client computing device 202 to (1) intercept, at proxy 102, server resource request 126 sent from at least one of client applications 124 and directed to server 206, (2) determine, at proxy 102, a modification for a server resource response based on the request, (3) apply, at proxy 102, the modification to the server resource response, and (4) send, from proxy 102, modified server resource response 128 to the client application.

Client computing device 202 generally represents any type or form of computing device capable of reading computer-executable instructions. For example, client computing device 202 may include a computing device capable of establishing connections with a remote web server (e.g., server 206) to send and receive data over one or more networks.

Additional examples of client computing device 202 include, without limitation, laptops, tablets, desktops, servers, cellular phones, Personal Digital Assistants (PDAs), multimedia players, embedded systems, wearable devices (e.g., smart watches, smart glasses, etc.), smart vehicles, smart packaging (e.g., active or intelligent packaging), gaming consoles, so-called Internet-of-Things devices (e.g., smart appliances, etc.), variations or combinations of one or more of the same, and/or any other suitable computing device.

Server 206 generally represents any type or form of computing device capable of reading computer-executable instructions. For example, server 206 may be a remote web server capable of establishing connections with client computing devices (e.g., client computing device 202) to facilitate the client computing devices sending and receiving data 208 (e.g., web pages, images, etc.) over one or more networks. Additional examples of server 206 include, without limitation, security servers, application servers, storage servers, and/or database servers configured to run certain software applications and/or provide various security, web, storage, and/or database services. Although illustrated as a single entity in FIG. 2, server 206 may include and/or represent a plurality of servers that work and/or operate in conjunction with one another.

Network 204 generally represents any medium or architecture capable of facilitating communication or data transfer. In one example, network 204 may facilitate communication between client computing device 202 and server 206. In this example, network 204 may facilitate communication or data transfer using wireless and/or wired connections. Examples of network 204 include, without limitation, an intranet, a Wide Area Network (WAN), a Local Area Network (LAN), a Personal Area Network (PAN), the Internet, Power Line Communications (PLC), a cellular network (e.g., a Global System for Mobile Communications (GSM) network), portions of one or more of the same, variations or combinations of one or more of the same, and/or any other suitable network.

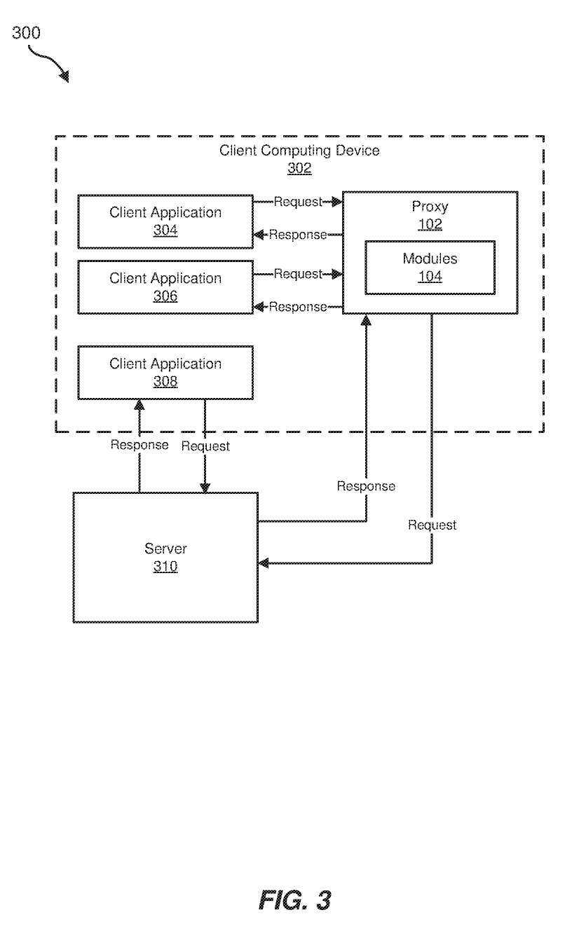

All or a portion of example system 100 may also represent portions of example system 300 in FIG. 3. As shown in FIG. 3, system 300 may include a client computing device 302 in communication with a server 310. In this example, client applications 304 and 306 may be configured to utilize modules 104 in proxy 102 to process server resource requests locally, while client application 308 may be configured to communicate directly with server 310 for the processing of server resource requests.

In one example, client applications 304 and 306 may include applications provided via a web browser that is compatible with proxy 102 while client application 308 may include an application provided via a web browser that is not compatible with proxy 102. In this example, both proxy 102 and server 310 may include parallel implementations of certain codepaths. For example, both proxy 102 and server 310 may be capable of servicing server resource requests from each of client applications 304, 306, and 308 by responding with the same server resource responses. Thus, by utilizing proxy 102 to at least partially perform processing of server resource requests and server resource responses locally, client applications 304 and 306 may reduce the processing load of server 310. In some examples, proxy 102 in system 300 may be utilized to enable additional clients and/or client applications to be supported by server 310 without increasing server resources or costs.

Proxy 102 may be implemented as a service worker executed in the background by a web browser shared by client applications 304 and 306. The term “service worker,” as used herein, generally refers to a background process of a web browser running on a client device. A service worker may be implemented in JavaScript, may control browser pages, and/or may communicate with pages they control by responding to messages via a postMessage interface. A service worker may also be an application programming interface (API) that may be capable of providing features that are not tied to a web page, may run in its own global script context with or without a web page, may run and/or terminate on an as-needed basis, and may have no document object model (DOM) access. A service worker may also be implemented in any other suitable manner. As a service worker, proxy 102, may be capable of intercepting and modifying server resource requests from client applications 304 and 306, as well as communicating modified server resource requests to a server and modifying responses received from the server to reduce the overall server processing load needed to support client applications 304 and 306.

FIG. 4 is a flow diagram of an example computer-implemented method 400 for modifying server resources using a client-side proxy. The steps shown in FIG. 4 may be performed by any suitable computer-executable code and/or computing system, including system 100 in FIG. 1, system 200 in FIG. 2, system 300 in FIG. 3, and/or variations or combinations of one or more of the same. In one example, each of the steps shown in FIG. 4 may represent an algorithm whose structure includes and/or is represented by multiple sub-steps, examples of which will be provided in greater detail below.

As illustrated in FIG. 4, at step 410 one or more of the systems described herein may intercept, at a proxy, a server resource request sent from a client application on a client device and directed to a remote server. For example, interception module 106 may, as part of proxy 102 on client computing device 202 in FIG. 2, intercept server resource request 126, sent from client application 124 and directed to server 206. Interception module 106 may intercept server resource request 126 in a variety of ways. For example, interception module 106 may use an event listener to intercept some or all requests made from a browser. Interception module 106 may also intercept requests in any other suitable manner.

Interception module 106 may intercept requests for any type of resource, including text resources, image resources, video resources, audio resources, etc. For example, interception module 106 may intercept a web server request for a modified image that is stored as raw data (e.g., an unaltered image) on server 206. In this example, the requested image may be a black-and-white, blurred version of an image stored as data 208 on server 206. As another example, interception module 106 may intercept a web server request for a raw, unmodified image stored on server 206.

At step 420 in FIG. 4, one or more of the systems described herein may determine, at the proxy, a modification for a server resource response based on the server resource request identified at step 410. For example, determination module 108 may, as part of proxy 102 on client computing device 202, determine a modification for a server resource response based on server resource request 126. Determination module 108 may determine a modification for a server resource response in a variety of ways.

In one example, determination module 108 may determine a modification for a server resource response by first determining if server resource request 126 is a request for a modified server resource (which may require additional processing by server 206) and, if so, change server resource request 126 to a request for an unmodified server resource to send to server 206. For example, if server resource request 126 from client application 124 is a request for a black-and-white, blurred version of an image, determination module 108 may change the request to a raw unformatted version of the image and send the request to server 206. Upon receiving the requested image from server 206, determination module 108 may then determine how to modify the received image. For example, determination module 108 may determine that additional processing (e.g., a filtering function) needs to be applied to the received image to generate the requested black-and-white, blurred version of the image prior to sending the image to client application 124.

In some examples, the additional processing may include processing that could be performed by server 206 but which would result in a large resource allocation burden being placed on server 206. In other examples, the additional processing may include processing that server 206 is not capable of. In these examples, proxy 102 may be utilized to extend server functionality by determining additional tasks needed to fulfill server resource request 126 from a client application 124. In some examples server 206 may perform some, but not all, needed processing on a resource, and then proxy 102 may perform the rest of the needed processing.

At step 430 in FIG. 4, one or more of the systems described herein may apply, at the proxy, the modification to the server resource response. For example, application module 110 may, as part of proxy 102 on client computing device 202, process a server resource response to server resource request 126 and then use the result to generate modified server resource response 128.

Application module 110 may apply the modification to the server resource response in a variety of ways (e.g., by removing content from a resource, by revising content of a resource, by enhancing a resource, by responding with a different resource than requested, etc.). For example, application module 110 may process an unmodified server resource (e.g., raw image data) returned from server 206 by applying filtering to generate a modified image.

In some examples, application module 110 may perform one or more tasks that are not capable of being performed by server 206. For example, application module 110 may apply further processing to a partially modified server resource to compensate for hardware or software processing limitations in server 206.

Application module 110 may also apply the modification to the server resource response by generating the server resource response without communicating with the remote server. For example, application module 110 may access a resource from a different server (e.g., as part of a load-balancing operation for a set of servers) or from a local cache and may then process the resource to generate the server resource response.

At step 440 in FIG. 4, one or more of the systems described herein may send, by the proxy, the modified server resource response to the client application. For example, sending module 112 may, as part of proxy 102 on client computing device 202, send modified server resource response 128 to a client application 124. In some examples, modified server resource response 128 may be sent from a browser running on client computing device 202. In this example, proxy 102 may include a process running on client device 202 that includes a background API of the browser.

Sending module 112 may send modified resource response 128 to client application 124 in a variety of ways. For example, sending module 112 may send modified server resource response 128 to multiple client applications 124 that all share proxy 102. In this example, client applications 124 may be part of a web domain in which multiple applications share a single local proxy, thereby avoiding duplication of logic between individual applications.

As another example, sending module 112 may send modified server resource response 128 to those of client applications 124 that share proxy 102, leaving other client applications 124 that do not share proxy 102 to receive server resource responses directly from server 206. In this example, and as discussed above in the description of FIG. 3, some client applications 124 may not be compatible with proxy 102, leaving server 206 to service their server resource requests directly.

As yet another example, sending module 112 may send modified server resource response 128 to a single client application among client applications 124. In this example, client applications 124 may each be associated with multiple proxies 102 that process server resource requests and server resource responses individually for each client application 124.

In FIG. 5, a communication chart 500 shows communications of a client device 502 (e.g., an instance of client computing device 202 of FIG. 2). FIG. 5 also shows a proxy 504 (e.g., an instance of proxy 102 of FIG. 2). At 508, proxy 504 may intercept a server resource request that was from a client application (e.g., one of client applications 124) on client device 502 and directed to a server 506 (e.g., an instance of server 206 of FIG. 2). At 510, proxy 504 may further determine a modification for a server resource response based on the request. At 512, proxy 504 may send a modified server resource request to server 506. For example, proxy 504 may send a request for a raw unformatted version of a formatted image requested in the server resource request received from client device 502.

At 514, proxy 504 may receive a server resource response from server 506. At 516, proxy 504 may apply the modification to the server resource response without fully relying on server 506 to process the response. For example, proxy 504 may apply filtering to generate a modified image from raw image data received from server 506. At 518, proxy 504 may send the modified server resource response to a client application 124 on client device 502.

As explained above in connection with FIGS. 1-5, one or more of the methods and/or systems described herein may offload work from servers to client applications without changing or complicating the logic of the servers. The proxy may be configured to intercept all resource requests originating from client applications over a network, modify the requests, modify responses to the requests, and/or construct entirely new responses to the requests. Moreover, the proxy may be shared between multiple client applications on a given web domain. In some examples, a proxy may be inserted between a client application and a server to provide additional processing for tasks that may either strain existing server resources and/or for tasks that a particular server is not capable of performing.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

The term “memory device,” as used herein, generally represents any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In addition, the term “physical processor,” as used herein, generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive networked server resources to be transformed, transform the server resource and output a result of the transformation to a client application that may use the result of the transformation to display data in a web browser. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

The term “computer-readable medium,” as used herein, generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
intercepting, at a proxy, a server resource request that was sent from a client application on a client device and directed to a remote server;
determining, at the proxy, a modification for a server resource response based on the server resource request;
applying, at the proxy, the modification to the server resource response; and
sending, from the proxy, the modified server resource response to the client application.

2. The computer-implemented method of claim 1, wherein the server resource request comprises a request for a modified server resource.

3. The computer-implemented method of claim 2, wherein determining, at the proxy, the modification for the server resource response based on the request comprises:
changing the request for the modified server resource to a request for an unmodified server resource;
sending the request for the unmodified server resource to the remote server;
receiving a response including the unmodified server resource from the remote server; and
determining how to modify the unmodified server resource.

4. The computer-implemented method of claim 1, wherein applying, at the proxy, the modification to the server resource response comprises generating the server resource response without communicating with the remote server.

5. The computer-implemented method of claim 1, wherein applying the modification to the server resource response comprises performing at least one task that the remote server is not capable of performing.

6. The computer-implemented method of claim 1, wherein the proxy comprises a process running on the client device.

7. The computer-implemented method of claim 6, wherein:
the client application comprises a web browser running on the client device;
the process running on the client device comprises a background application programming interface of the web browser.

8. A system comprising:
an interception module that intercepts, at a proxy, a server resource request that was sent from a client application on a client device and directed to a remote server;
a determination module that determines, at the proxy, a modification for a server resource response based on the server resource request;
an application module that applies, at the proxy, the modification to the server resource response;
a sending module that sends, from the proxy, the modified server resource response to the client application; and
at least one physical processor configured to execute the interception module, the determination module, the application module, and the sending module.

9. The system of claim 8, wherein the server resource request comprises a request for a modified server resource.

10. The system of claim 9, wherein the determining module determines, at the proxy, a modification for a server resource response based on the request by:
changing the request for the modified server resource to a request for an unmodified server resource;
sending the request for the unmodified server resource to the remote server;
receiving a response including the unmodified server resource from the remote server; and
determining how to modify the unmodified server resource.

11. The system of claim 8, wherein the application module applies, at the proxy, the modification to the server resource response by generating the server resource response without communicating with the remote server.

12. The system of claim 8, wherein the application module applies the modification to the server resource response by performing at least one task that the remote server is not capable of performing.

13. The system of claim 8, wherein the proxy comprises a process running on the client device.

14. The system of claim 13, wherein:
the modified server resource response is sent from a browser running on the client device; and
the process running on the client device comprises a background application programming interface of the browser.

15. A computer-readable medium comprising:
computer-executable instructions that, when executed by a physical processor of a computing device, cause the computing device to:
intercept, at a proxy, a server resource request that was sent from a client application on a client device and directed to a remote server;
determine, at the proxy, a modification for a server resource response based on the server resource request;
apply, at the proxy, the modification to the server resource response; and
send, from the proxy, the modified server resource response to the client application.

16. The computer-readable medium of claim 15, wherein the server resource request comprises a request for a modified server resource.

17. The computer-readable medium of claim 16, wherein the computer-executable instructions cause the computing device to determine, at the proxy, the modification for the server resource response based on the request by:
changing the request for the modified server resource to a request for an unmodified server resource;
sending the request for the unmodified server resource to the remote server;
receiving a response including the unmodified server resource from the remote server; and
determining how to modify the unmodified server resource response.

18. The computer-readable medium of claim 15, wherein the computer-executable instructions cause the computing device to apply, at the proxy, the modification for the server resource response based on the server resource request by generating the server resource response without communicating with the remote server.

19. The computer-readable medium of claim 15, wherein the computer-executable instructions cause the computing device to apply, at the proxy, the modification for the server resource response based on the server resource request by performing at least one task the remote server is not capable of performing.

20. The computer-readable medium of claim 15, wherein the proxy comprises a process running on the client device.
